(19) United States
(12) Patent Application Publication
(10) Pub. No.: US 2024/0411526 A1
(43) Pub. Date: Dec. 12, 2024

(54) METHOD, APPARATUS, DEVICE FOR CREATING A PLUG-IN AND STORAGE MEDIUM

(71) Applicants: Beijing Zitiao Network Technology Co., Ltd., Beijing (CN); Lemon Inc., Grand Cayman (KY)

(72) Inventors: Yiguo Wang, Beijing (CN); Xin Zhong, Beijing (CN); Jue Huang, Beijing (CN); Yang Liu, Beijing (CN); Yibing Zhu, Los Angeles, CA (US)

(21) Appl. No.: 18/812,878

(22) Filed: Aug. 22, 2024

(30) Foreign Application Priority Data
Aug. 25, 2023 (CN) 202311085046.3

(51) Int. Cl. G06F 8/30

(52) U.S. Cl. CPC G06F 8/30

(57) ABSTRACT

According to an embodiment of the disclosure, methods, apparatuses, devices, and storage medium for creating plug-ins are provided. The method includes: providing a plug-in creation portal in a first page associated with an interaction window between a digital assistant and a first user; providing a second page for creating a target plug-in based on a selection of the plug-in creation portal; obtaining inputted plug-in creation information about the target plug-in via the second page; and in response to receiving an operation of releasing the target plug-in, releasing the target plug-in based on the plug-in creation information, the released target plug-in being selectable for an interaction between a user and the digital assistant. In this way, the user can conveniently and quickly complete the creation of the plug-in, thereby helping the user to efficiently complete diversified operations by means of the plug-in during the interaction with the digital assistant.

### CROSS REFERENCE

This application claims priority of the Chinese patent application No. 202311085046.3, entitled “METHOD, APPARATUS, DEVICE FOR CREATING A PLUG-IN AND STORAGE MEDIUM” filed on Aug. 25, 2023, the entire content of which is incorporated herein by reference.

### FIELD

Example embodiments of the present disclosure generally relate to the field of computers, and in particular, to methods, apparatuses, devices, and computer-readable storage medium for creating a plug-in.

### BACKGROUND

With the development of information technologies, various terminal devices may provide various services to people in terms of work and life. For example, an application providing a service may be deployed in the terminal device. The terminal device or application may provide a digital assistant type function to the user to assist the user in using the terminal device or application. The user can complete diversified operations by means of a plug-in during the interaction with the digital assistant. How to enable a user to create a plug-in conveniently and quickly is a technical problem to be explored currently.

### SUMMARY

In a first aspect of the present disclosure, a method for creating a plug-in is provided. The method comprises: providing a plug-in creation portal in a first page associated with an interaction window between a digital assistant and a first user; providing a second page for creating a target plug-in based on a selection of the plug-in creation portal; obtaining inputted plug-in creation information about the target plug-in via the second page; and in response to receiving an operation of releasing the target plug-in, releasing the target plug-in based on the plug-in creation information, the released target plug-in being selectable for an interaction between a user and the digital assistant.

In a second aspect of the present disclosure, an apparatus for creating a plug-in is provided. The apparatus includes: a portal provision module, configured to provide a plug-in creation portal in a first page associated with an interaction window between a digital assistant and a first user; a page provision module, configured to provide a second page for creating a target plug-in based on a selection of the plug-in creation portal; an information obtaining module, configured to obtain inputted plug-in creation information about the target plug-in via the second page; and a plug-in release module, configured to in response to receiving an operation of releasing the target plug-in, release the target plug-in based on the plug-in creation information, the released target plug-in being selectable for an interaction between a user and the digital assistant.

In a third aspect of the present disclosure, an electronic device is provided. The electronic device includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer-readable storage medium stores a computer program, and the computer program is executable by a processor to implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A, 2B, and 2C illustrate schematic diagrams of example interfaces for creating a plug-in according to some embodiments of the present disclosure;

FIGS. 3A and 3B illustrate schematic diagrams of example pages for creating a plug-in according to some embodiments of the present disclosure;

FIGS. 4A, 4B, and 4C illustrate schematic diagrams of example pages for releasing a plug-in according to some embodiments of the present disclosure;

FIG. 5 illustrates a schematic diagram of an example architecture for creating a plug-in according to some embodiments of the present disclosure;

FIG. 6A and FIG. 6B illustrate schematic diagrams of an example page for creating a plug-in in an application according to some embodiments of the present disclosure;

FIG. 7 illustrates a flowchart of a process for creating a plug-in according to some embodiments of the present disclosure;

FIG. 8 illustrates a block diagram of an apparatus for creating a plug-in according to some embodiments of the present disclosure; and

FIG. 9 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below.

Herein, unless explicitly stated, “in response to A” performing a step does not mean that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in the embodiments of the present disclosure, relevant user should be informed of the types, use ranges, usage scenarios, and the like of the information related to the present disclosure in an appropriate manner according to relevant laws and regulations, and the authorization of the related user may be obtained, wherein the relevant users may include any type of rights body, such as individuals, businesses, and groups.

For example, when an active request of a user is received, prompt information is sent to the related user to explicitly prompt the related user, and the operation requested to be performed will need to obtain and use the information of the related user, so that the related user can autonomously select whether to provide information to software or hardware such as electronic device, application, server or storage medium and etc., executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

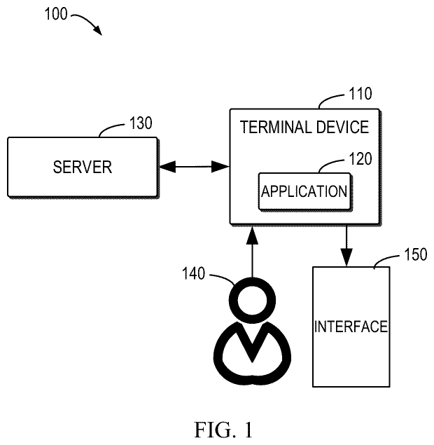

FIG. 1 illustrates a schematic diagram of an example environment 100 in which embodiments of the present disclosure can be implemented. In this example environment 100, an application 120 is installed in the terminal device 110. The user 140 may interact with the application 120 via the terminal device 110 and/or an attached device of the terminal device 110.

In some embodiments, the application 120 may be downloaded and installed on the terminal device 110. In some embodiments, the application 120 may also be accessed in other manners, such as via web page access. In the environment 100 of FIG. 1, if the application 120 is launched, the terminal device 110 may present the interface 150 of the application 120. The interface 150 may include various user interfaces that can be provided by the application 120. In some cases, the interface 150 is also referred to as a user interface.

The applications 120 include, but are not limited to, one or more of the following: chat applications (also known as instant messaging applications), document applications, audio and video conference applications, mail applications, task applications, objectives and key results (OKR) applications, and the like. Application 120 supports the use of plug-ins. Such plug-ins include, but are not limited to, one or more of a search plug-in, a contact plug-in, a messaging plug-in, a documentation plug-in, a table plug-in, a mail plug-in, a calendar plug-in, a schedule plug-in, a task plug-in, and the like. In some embodiments, the application 120 may include a multifunction collaboration platform, such as an office collaboration platform (also referred to as an office suite), which can provide integration of multiple types of applications or components to facilitate people's office, communication, and other activities. In the multifunctional collaboration platform, people may launch different applications or components according to their needs to complete corresponding information processing, sharing, communication and the like.

In some embodiments, terminal device 110 communicates with server 130 to enable provisioning of services to application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, etc.). Applications 130 may be various types of computing systems/servers capable of providing computing power, including, but not limited to, mainframes, edge computing nodes, computing devices in a cloud environment, and so forth.

It should be understood that the structures and functions of the various elements in the environment 100 are described for exemplary purposes only and do not imply any limitation to the scope of the present disclosure.

As briefly mentioned above, a digital assistant may assist a user in using a terminal device or application. Some applications can provide integrated functionality for different plugins. In addition to freely conversing with the digital assistant, the user may use different plug-ins through the natural language instruction make the digital assistant complete some more complex operations related to the service of the application by using, such as creating a document, inviting and scheduling, creating a task, and the like. Traditional plug-ins often require relevant professionals (e.g., back-end programmers of applications) to create. This makes the threshold of creating the plug-in relatively high, and the users cannot implement flexible plug-in creation based on their own needs.

According to some embodiments of the present disclosure, an improved solution for creating a plug-in is presented. In an embodiment of the present disclosure, a plug-in creation portal is provided in a first page associated with an interaction window between a digital assistant and a first user. A second page for creating a target plug-in is provided based on a selection of the plug-in creation portal. Inputted plug-in creation information about the target plug-in is obtained via the second page. In response to receiving an operation of releasing the target plug-in, the target plug-in is released based on the plug-in creation information. The released target plug-in is selectable for an interaction between a user and the digital assistant. Therefore, the user can conveniently and quickly complete the creation of plug-in. In this way, it is helpful to enable the user to efficiently complete diverse operations by means of the plug-in during the interaction with the digital assistant. For example, in some embodiments, the user selects a calendar plug-in during interaction with the digital assistant, and then the user sends an instruction for creating a schedule to the digital assistant, so that the digital assistant can create a corresponding schedule by using the calendar plug-in, and return the result of the creation to the user.

Some example embodiments of the present disclosure will be described in detail below with reference to examples of the accompanying drawings.

In an embodiment of the present disclosure, the digital assistant is configured to interact with a user. An interaction window between the user and the digital assistant may be presented in the user interface. The interaction window between the user and the digital assistant may include a session window, and the interaction between the user and the digital assistant in the session window may be presented in a form of a session message. Alternatively or additionally, the interaction window between the user and the digital assistant may further include other types of windows, such as a window of a floating window mode, where the user may trigger the digital assistant to perform a corresponding operation by inputting an instruction, selecting a shortcut instruction, or the like. The digital assistant serves as an intelligent assistant, and has an intelligent conversation and information processing capability. In the interaction window, the user inputs an interaction message, and the digital assistant provides a reply message in response to the user input. A user interface for providing a digital assistant may correspond to a single function application or a multifunction collaboration platform, such as an office suite or other collaboration platform capable of integrating a plurality of components.

The digital assistant may be invoked or awakened in an appropriate manner (e.g., shortcut button, button, or voice) to present an interaction window with the user. In some embodiments, the digital assistant may be included in the contact list of the application of the current user as a contact of the user, or included in the information stream of the chat application. By selecting the digital assistant, an interaction window with the digital assistant may be opened. The interaction window may include interface elements for task processing, such as input boxes, message lists, message bubbles, and the like. In some other embodiments, the digital assistant may be invoked through an portal control or a menu provided in the page, or may be invoked by inputting a predetermined instruction. In some embodiments described below, for case of discussion, the interaction window between the user and the digital assistant being a session window is mainly used as an example for description.

In some embodiments, a plurality of interaction modes between a user and a digital assistant may be provided, and may be flexibly switched between a plurality of interaction modes. In the scenario that a certain interaction mode is triggered, a corresponding interaction area is presented to facilitate the user to interact with the digital assistant. The interaction manners between the user and the digital assistant in different interaction mode are different, which can flexibly adapt to interaction requirements in different application scenarios.

In some embodiments, the user has a correspondence relationship with the digital assistant. For example, the first digital assistant corresponds to the first user, the second digital assistant corresponds to the second user, and so on. In some embodiments, the first digital assistant may uniquely correspond to the first user, the second digital assistant may uniquely correspond to the second user, and so on. That is, the first digital assistant of the first user may be specific or dedicated to the first user. For example, in a process in which the first digital assistant provides assistance or service for the first user, the first digital assistant may utilize its historical interaction information with the first user, data authorization by the first user that can be accessed by the first digital assistant, current interaction context between the first digital assistant and the first user, and the like. If the first user is an individual or a person, the first digital assistant may be considered a personal digital assistant. It may be understood that, in the disclosed embodiment, the first digital assistant access the data that is granted permission based on the authorization of the first user. It should be understood that the “unique correspondence” or the like in this disclosure is not intended to limit that the first digital assistant will be updated accordingly based on the interaction process between the first user and the first digital assistant.

In some embodiments, an information processing service specific to the user can be provided based on historical interaction information between the user and the digital assistant and/or a data scope specific to the user. In some embodiments, the historical interaction information of the user interacting with the digital assistant in the plurality of interaction modes may all be stored in association with the user. As such, in one of the plurality of interaction modes (any one or designated one of the interaction modes), the digital assistant may provide services to the user based on historical interaction information stored in association with the user.

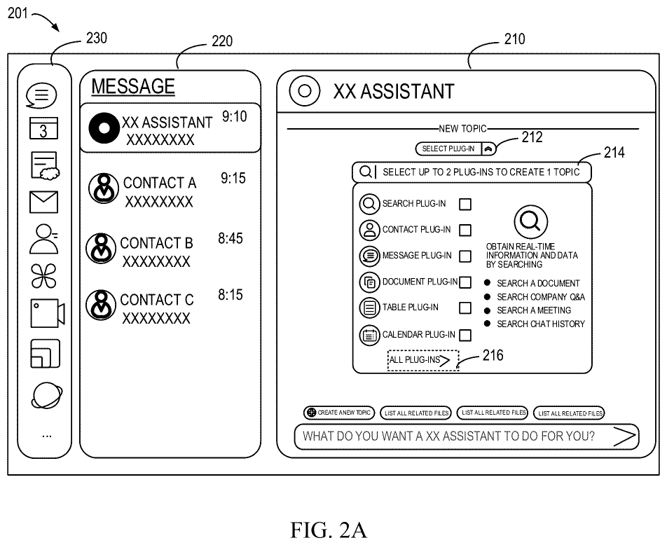

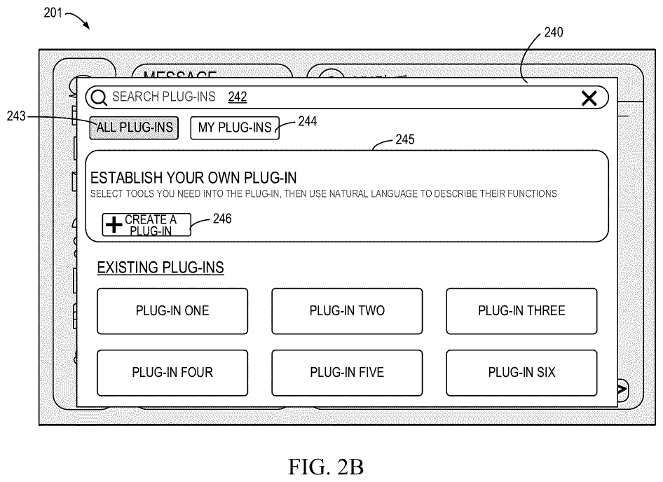

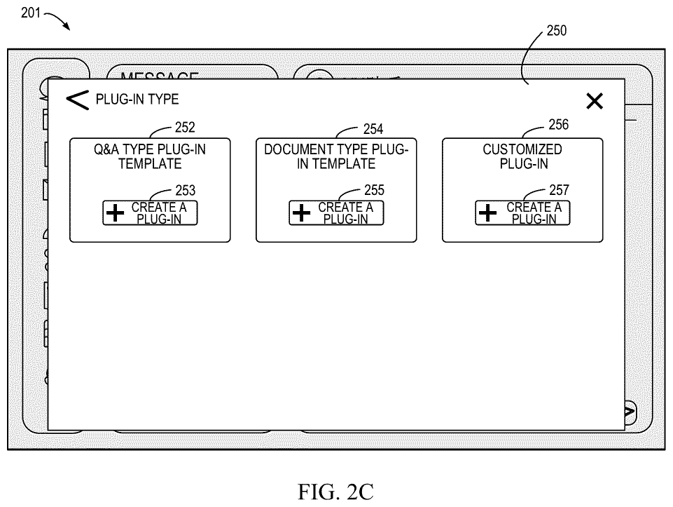

FIG. 2A to FIG. 2C illustrate schematic diagrams of an example user interface 201 for creating a plug-in according to some embodiments of the present disclosure. The user interface 201 may be implemented at the terminal device 110. Examples of FIG. 2A to FIG. 2C are described below with reference to FIG. 1.

In some embodiments, in response to a user (for example, the user 140) calling the digital assistant through a predetermined operation (for example, selecting a digital assistant from a contact list), the terminal device 110 may present a session window (also referred to as a main session window) that the user interacts with the digital assistant and a plug-in selection control. Through such a plug-in selection control, the user may select the plug-in to use in the main session window.

In some embodiments, as shown in FIG. 2A, the main session window between a digital assistant (shown as “XX assistant” in the figure) and the user is presented in the region 210 of interface 201. The digital assistant may be viewed as one of the users' contacts, presented in the information stream of the instant messaging application. The instant messaging application is presented in region 230 of interface 201, and the information stream is presented in the region 220 of the interface 201. The user selects the digital assistant in the instant messaging application to enter the main session window. The main session window includes a plug-in selection control 212. The user may select a plug-in to use in the session window by clicking on the plug-in selection control 212.

In some embodiments, the terminal device 110 invokes a digital assistant in a page (for example, a page of browsing a document) in response to a predetermined operation from the user (for example, triggering a predetermined control, inputting a predetermined instruction or a voice wakeup, and the like), and presents a sub-session window in which the user interacts with the digital assistant. Such a sub-session window includes a plug-in selection control. Through such a plug-in selection control, the user may select and use the plug-in in the sub-session window.

In some embodiments, in response to detecting a selection operation (e.g., a click operation) of the plug-in selection control 212, the terminal device 110 may present the plug-in selection panel 214. The plug-in selection panel 214 presents at least one plug-in that has been created (e.g., a search plug-in, a contact plug-in, a message plug-in, etc. shown in FIG. 2A). In some embodiments, a plug-in viewing control 216 is also presented in the plug-in selection panel 214. The terminal device 110, in response to detecting the selection operation of the plug-in viewing control 216, presents all plug-ins selectable by the user during the interaction with the digital assistant.

In some embodiments, in response to detecting a selection operation of the plug-in viewing control 216, the terminal device 110 may also present a plug-in creation page (also referred to as a first page) in the interface 201. Such a first page may be any suitable page accessible via the interaction window between the current user and the digital assistant. In some embodiments, the plug-in creation page may include a message display area in a session window between the first user and the digital assistant.

As shown in FIG. 2B, in response to detecting a selection operation of the plug-in viewing control 216 in FIG. 2A, the terminal device 110 may also present a plug-in creation page 240 in the interface 201. Only the manner in which the plug-in creation page 240 is presented on the upper side of the interface 201 and is included in the interface 201 is taken as an example for description in FIG. 2B. In other embodiments, they may be arranged in other manners as required.

In some embodiments, a plug-in creation portal may also be provided in the plug-in selection panel 214 of FIG. 2A to switch to a plug-in creation page directly via the plug-in selection panel 214. For example, a page corresponding to the interface 201 may be switched to the plug-in creation page 240.

In some embodiments, a plug-in search function may be provided in the plug-in creation page 240 for searching for plug-ins from existing plug-ins. As shown in FIG. 2B, the plug-in creation page 240 includes a search box 242. The user may enter at least a portion of the name of the plug-in to be searched in the search box 242. In some embodiments, the plug-in creation page 240 may present search results in association with the search box 242. For example, if the user input received in the search box 242 is “search”, the plug-in creation page 240 may present search results in association with the search box 242, such as “search a plug-in”, a “search a contact”, “search a document”, “search a table”, or the like. Additionally or alternatively, the plug-in selection panel provides a fuzzy search function.

In some embodiments, the plug-in creation page 240 further includes a control 243 and a control 244. The terminal device 110 may, for example, in response to detecting a selection operation of the control 243, present all the stored plug-ins (which may be referred to as a first set of plug-ins) in the plug-in creation page 240. For example, as shown in FIG. 2B, in response to detecting a selection operation of the control 243, the terminal device 110 presents, at the “existing plug-in”, a plug-in that has been created, such as a plug-in one, a plug-in two, and a plug-in three. The plug-in may be created by the current user, or may be shared by other users after the creation to the current user for use by the current user. For example, the terminal device 110 may only present, in the plug-in creation page 240, a plug-in (for example, may be referred to as a second set of plug-ins) created by the current user in response to detecting a selection operation of the control 244. It may be understood that the first set of plugins includes a second set of plugins, and the number of plugins included in the first set of plugins may be greater than or equal to the number of plugins included in the second set of plugins. In some embodiments, in response to the plug-in creation page 240 being presented, the terminal device 110 may default to present the first set of plug-ins corresponding to the control 243, and switch to presenting the second set of plug-ins upon detecting the selection operation of the control 244.

In some embodiments, the plug-in creation page 240 also includes a plug-in creation area 245. The plug-in creation area 245 may be used, for example, to present a text description indicating the user to create the plug-in. The plug-in creation area 245 may also be presented with a plug-in creation control 246 (also referred to as a plug-in creation portal). For example, the terminal device 110 may present a creation page (also referred to as a second page) of the plug-in based on detecting a selection operation of the plug-in creation control 246. In some embodiments, before presenting the creation page of the plug-in, the terminal device 110 may further present, in response to detecting a selection operation of the plug-in creation control 246, a type selection page (also referred to as a third page) for selecting a plug-in type of the plug-in to be created. For example, as shown in FIG. 2B and FIG. 2C, the terminal device 110 may, for example, present the type selection page 250 based on detecting a selection operation of the plug-in creation control 246. Similar to the plug-in creation page 240, only the manner in which the type selection page 250 is presented on the upper side of the interface 201 and included in the interface 201 is taken as an example for description in FIG. 2C. In other embodiments, they may be arranged in other manners as required.

As shown in FIG. 2C, the type selection page 250 includes a plurality of type selection areas corresponding to different plug-in types. In some embodiments, considering that the intelligent questioning and answering are a quite general demand scenario for a user, in an implementation aspect, the process of knowledge questioning and answering is composed of two key parts of a search vector recall and a model generated answer, and links of different scenarios have high degree of multiplexing. In view of this, it is necessary to use the questioning and answering type plug-in as an application scenario in the creation process of the digital assistant plug-in, to reduce the questioning and answering configuration threshold, and enable the user to quickly create one or more questioning and answering type plug-ins for putting into daily use. Therefore, in some embodiments, the type selection page 250 includes at least a selection area 252 corresponding to the questioning and answering type plug-in template and a creation control 253 for creating a plug-in corresponding to the questioning and answering type plug-in template. In addition to the questioning and answering type plug-in, other plug-in types may include, but are not limited to, a document type plug-in, a customized plug-in, a mail type plug-in, a search type plug-in, and the like.

As an example, in FIG. 2C, the plurality of type selection areas included in the type selection page 250 may include, for example, a selection area 252 corresponding to the questioning and answering type plug-in template, a selection area 254 corresponding to the document type plug-in template, and a selection area 256 corresponding to the customized plug-in. It may be understood that more regions corresponding to other template types may also be included in the type selection page 250, which is not limited in the present disclosure. Each region includes a creation control (also referred to as a second plugin creation portal) associated with a corresponding plugin type. For example, the area 252 includes a corresponding creation control 253, which is used to create a plug-in corresponding to the questioning and answering type plug-in template; and the area 254 includes a creation control 255, which is used to create a plug-in corresponding to the document type plug-in template, and the area 256 includes a creation control 257, which is used for user flexibly customization.

In some embodiments, based on detecting a selection of a plug-in creation portal in a window corresponding to any type (e.g., creation control 246 in the example of FIG. 2B, creation control 253, creation control 255, and creation control 257 in the example of FIG. 2C, etc.), terminal device 110 determines that a plug-in creation request for a plug-in of the type is received, and then based on the plug-in creation request, provides a creation page (i.e., a second page) for creating a plug-in (sometimes also referred to herein as a target plug-in). For example, in response to detecting the selection operation of the creation control 253 in the example of FIG. 2C, the terminal device 110 determines that the plug-in creation request indicating the creation of the questioning and answering type plug-in is received, and further provides a creation page for creating the questioning and answering type plug-in. In response to detecting the selection operation of the creation control 255 in the example of FIG. 2C, the terminal device 110 determines that the plug-in creation request indicating the creation of the document type plug-in is received, and further provides a creation page for creating the document type plug-in. In response to detecting the selection operation of the creation control 257 in the example of FIG. 2C, the terminal device 110 determines that a plug-in creation request indicating the creation of the customized plug-in is received, and further provides a creation page for creating the customized plug-in.

It should be understood that FIG. 2A to FIG. 2C illustrate example interfaces for initiating a plug-in creation request, including initiating a template-based plug-in creation request. In a specific application, any interface interaction manner may be designed as required, or a plug-in creation portal may be provided in any other appropriate page, to facilitate the user to initiate the plug-in creation request.

In some embodiments, to facilitate a more efficient creation of plug-ins by users, one or more types of plug-in creation templates are provided. If the user requests to perform a plug-in creation according to a specific type of plug-in creation template, the creation page for creating the plug-in includes a plug-in creation template corresponding to the type of the plug-in to be created. The plug-in creation template includes at least one information input component. In some embodiments, the plug-in creation template herein is determined based on template information corresponding to the plug-in type. The template information herein at least indicates at least one information input component required for creating a plug-in corresponding to the plug-in type.

Therefore, the user may determine the corresponding template information based on the plug-in type expected to be created by the user, and further determine the creation page including the corresponding plug-in creation template.

In some embodiments, depending on the type of plug-in to be created, the information input component provided by the corresponding plug-in creation template may include a list of tools selectable under the type. In general, a plug-in may be understood as a collection of functions, while a “tool” in a plug-in may be understood as a unit function or an atomic function in a plug-in. With a plurality of tools, the plug-in can ultimately be used to handle a type of tasks desired by the user. For example, a plug-in for processing a document may include a document creation tool for creating a new document; a search tool for performing a search in the document; a formula generation tool for generating and inserting a formula in the document, and so on.

In some embodiments, in order to distinguish the plurality of plug-ins, no matter the creation page corresponds to the creation page of which plug-in type, the plug-in creation template may include an information input component for inputting identification information (for example, a text identifier and/or an image identifier) of the plug-in, and/or an information input component for inputting the description text of the plug-in, and the like. The terminal device 110 may obtain, via at least one information input component in the plug-in creation template, plug-in creation information about the plug-in to be created.

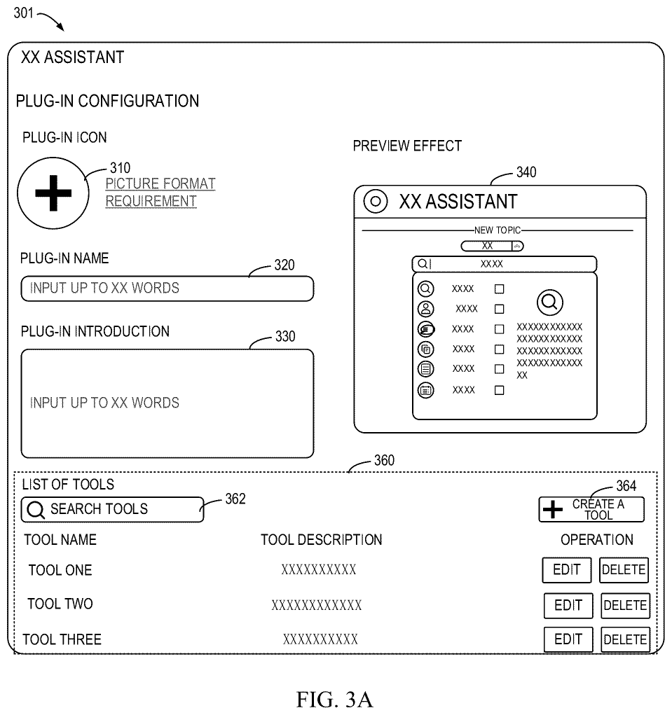

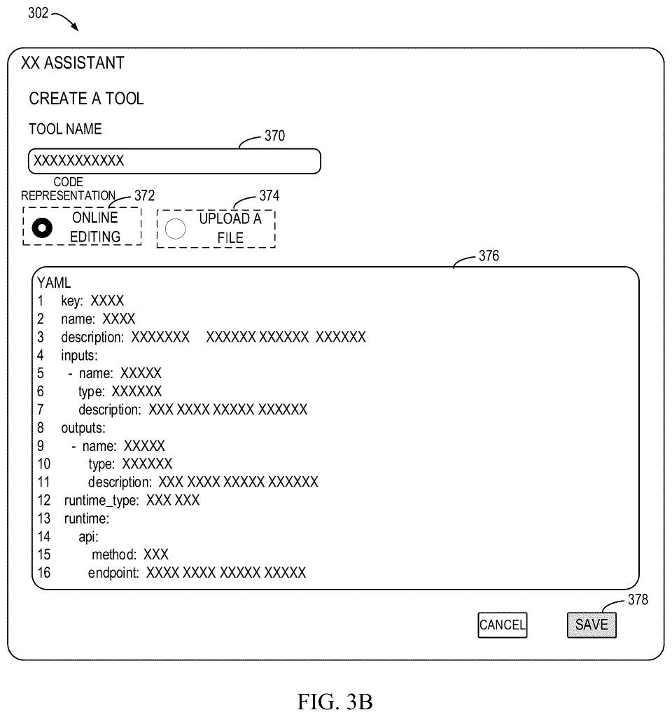

FIG. 3A and FIG. 3B illustrate schematic diagrams of example pages for creating a plug-in according to some embodiments of the present disclosure. The example pages 301 and 302 may be implemented at the terminal device 110. Examples of FIG. 3A and FIG. 3B are described below with reference to FIG. 1.

In some embodiments, based on detecting a selection operation of a plug-in creation portal (e.g., creation control 246 in FIG. 2B), terminal device 110 may present the creation page 301 for creating a plug-in as shown in FIG. 3A.

As shown in FIG. 3A, the creation page 301 includes an information input component 310 for inputting an image identifier (e.g., an icon) of the plug-in, an information input component 320 for inputting a text identifier (for example, a name) of the plug-in, and an information input component 330 for inputting the description text (for example, an introduction). The information input component 310 and the information input component 320 are both information input components for inputting identification information of the plug-in. The terminal device 110 may obtain the icon of the plug-in via the information input component 310, obtain the name of the plug-in via the information input component 320, and obtain the introduction text of the plug-in via the information input component 330. Additionally, or alternatively, if the character input in the information input component 320 exceeds a first character threshold (e.g., 16 characters), the exceeded character is directly truncated or the input is limited. Additionally or alternatively, if the character input in the information input component 330 exceeds a second character threshold (e.g., 54 characters), the exceeded character is directly truncated or the input is limited.

In some embodiments, for the image identifier of the plug-in, it is supported that an image of a specified format may be obtained through the information input component 310. For example, the terminal device 110 only supports obtaining the picture in the PNG format through the information input component 310. In this case, the user may click on an portal such as “picture format requirement” to view the format requirements for the image identifier. The terminal device 110 may present, in response to detecting a click operation of the “picture format requirement”, a description text indicating a format requirement. Additionally, or alternatively, if the picture format obtained by the terminal device 110 through the information input component 310 does not meet the specification, it cannot be uploaded successfully. In this case, the image identifier applies a default image identifier.

In some embodiments, the creation page 301 may further include an effect presentation area 340 for presenting the plug-in preview information. The effect presentation area 340 may present a preview effect of the plug-in to be created. In some embodiments, the creation page 301 may further include an information input component for determining permission information of the plug-in. Such permission information may, for example, indicate a user range capable of using the plug-in. For example, if the terminal device 110 obtains the identification information (for example, the name of the user A) corresponding to the user A through such a information input component, the terminal device 110 may determine that the user A may use the plug-in.

In some embodiments, the creation page 301 may also include an information input component 360 of one or more tools. The information input component 360 may include a search box 362. The terminal device 110 may search and obtain a plurality of tools based on the user input obtained in the search box 362. A plurality of pre-obtained candidate tools (also referred to as a set of candidate tools) may be presented in the information input component 360, such the plurality of candidate tools may be tools that the current user has permission to use. For example, the candidate tools may include tools created by the current user, or tools that are shared by other users, after the creation, to the current user for use by the current user.

In some embodiments, such the plurality of candidate tools may include a set of candidate tools (also referred to as a first set of candidate tools) determined based on the current user's permission information. Additionally, or alternatively, the candidate tool may also include a set of candidate tools (also referred to as a second set of candidate tools) edited or uploaded by the current user. Additionally, or alternatively, the candidate tool may further include a set of candidate tools (also referred to as a third set of candidate tools) determined based on an application (also referred to as a target application) associated with the target plug-in. For example, if the target application is a document type application, the associated plug-in may include: a document creation tool, a document editing tool, a search tool, and the like. For another example, if the target application is a schedule application, the associated plug-in may include: a to-do item creation tool, a reminder setting tool, and the like. In this way, differentiated presentation of tools may be implemented, and thus a user may be supported to quickly create a plug-in that is within the permission range or a plug-in that more conform to an expectation of the user.

The candidate tools may be presented in the information input component 360 in a tool list manner. The terminal device 110 may determine, in response to selection of one or more tools in the tool list by a user, a tool (also referred to as a first tool) for creating the target plugin, e.g., tool one, tool two, and tool three shown in the information input component 360. A tool name, tool description, and the operation corresponding to each tool are presented in the tool list. The operations herein may include, for example, editing operations and deleting operations.

Additionally, or alternatively, the terminal device 110 may provide a pop-up window for the secondary confirmation in response to the deleting operation. In addition, the terminal device 110 may delete the tool in response to an operation of a confirmation of the deletion operation in the pop-up window. The tool list of the information input component 360 may include, for example, controls corresponding to operations, such as “edit control” and “delete control”. The terminal device 110 may perform an operation corresponding to the tool in response to detecting a selection operation of a certain control. For example, the terminal device 110 may determine to perform an editing operation on the tool one in response to detecting a selection operation of an edit control for the tool one. In some embodiments, the terminal device 110 may present a respective page for performing an operation. For example, an editing page of an editing operation on a tool may be performed.

According to the foregoing embodiment, the user may determine the selected tool as the tool to be included in the target plug-in, or may edit or delete the selected tool to re-determine the tool to be included in the target plug-in. If the user desires that a created plug-in needs a new function, it is also supported that the user can create a new tool to support such a new function.

In some embodiments, the terminal device 110 may obtain tool creation information about a tool to be created (also referred to as a second tool). In turn, the terminal device 110 may create a tool based on such tool creation information. For example, as shown in FIG. 3A, the information input component 360 may further include a tool creation control 364. The terminal device 110 may present, in response to detecting a selection operation of the tool creation control 364, a creation page for creating a new tool, e.g., a tool creation page 302 as shown in FIG. 3B. Such a tool creation page 302 includes an information input component 370 for inputting the text identifier of the tool, such as a tool name. The terminal device 110 may obtain the name of the tool via the information input component 370.

In some embodiments, the tool creation page 302 may also include a code representation associated with the tool to be created. Such a code representation may be a code representation (also referred to as a first code representation) entered via a code editing control. As shown in FIG. 3B, the tool creation page 302 may include a code editing control 372 for editing code. The terminal device 110 may provide the information input component 376 based on a selection operation of the code editing control 372 by the user. The terminal device 110 may obtain the code edited by the user via the information input component 376. Such code may, for example, define the version number, creator, attribute of the tool itself, feature, implementation and usage permission, etc. of the tool.

In some embodiments, the tool creation page 302 may also include a code representation (also referred to as a second code representation) uploaded by the user. As shown in FIG. 3B, the tool creation page 302 may include a code upload control 374 for uploading a code file. The terminal device 110 may provide a corresponding component (such as a control of browsing a file, control of confirming an upload, control of inputting a hyperlink, and the like) based on the selection operation of the code upload control 374 by the user. The terminal device 110 may obtain the code via these controls. Additionally, or alternatively, such uploaded code may also be presented in the information input component 376 to support the user to perform a secondary editing. Correspondingly, the terminal device 110 may switch from the state of the selected code upload control 374 to the state of the selected code editing control 372.

Through the above example embodiment, the present disclosure can support a user creating a tool in a more flexible manner thereby creating a plug-in. However, the tools created by the user need to be verified to ensure normalization or security. In some embodiments, the terminal device 110 may verify the code representation of the tool in response to the completion operation of editing or uploading the code representation (e.g., operation of clicking the save control). Such verification may be performed automatically based on some predetermined rules, or may be submitted to a verification personnel for manual verification. Further, the terminal device 110 may create a corresponding tool in response to the code representation passing the verification. The terminal device 110 may also provide an error prompt associated with the code representation in response to the code representation failing to pass the verification.

Illustratively, the tool creation page 302 may also include a save control 378 for submitting code. The terminal device 110 verifies the code representation of the tool to be created in response to the selection operation of the save control 378 by the user. If an error is detected while verification, the terminal device 110 prompts the error content in a pop-up window. The terminal device 110 may stay in the tool creation page 302 in response to the operation of closing the pop-up window by the user to support the user continuing to edit the code representation, upload the code representation, or return the creation page 301 of the plug-in in response to the selection operation of the cancel control by the user. If the verification is passed, the terminal device 110 may prompt that the saving is successful and return the creation page 301 of the plug-in. It should be understood that the present disclosure does not limit the verification content of the code representation and the possible error prompt.

In some embodiments, the terminal device 110 returns the creation page of the plugin and displays the newly successfully created tool on top of the tool list in response to the code representation passing the verification. For example, as shown in FIG. 3A, the terminal device 110 displays the newly successfully created tool in the tool list of the information input component 360.

In some embodiments, the creation page 301 may further include a tool permission information management control. The tool permission information may indicate usage constraints of other users with respect to tools created by the current user. For example, the terminal device 110 may provide the permission setting control of the corresponding tool in response to the selection operation of the tool permission information management control by the user.

Additionally, or alternatively, the terminal device 110 may further provide a permission information management page of all tools created by the current user. Such a page may include view information such as, for example, a created tool list, a corresponding permission (for example, a permission requiring an audit, an audit free permission, etc.), whether to activate and etc. Such a page may also include a permission setting control or the like corresponding to each tool.

According to the foregoing embodiment, the user may be supported to edit and input the plug-in creation information according to needs. Further, the terminal device 110 may release the plug-in based on the plug-in creation information, and the released plug-in may be selected for user interaction with the digital assistant. Such interaction may be limited to the interaction between the current user and the digital assistant, as well as interaction between other user with the respective digital assistant, depending on the permission configuration of the created plugin.

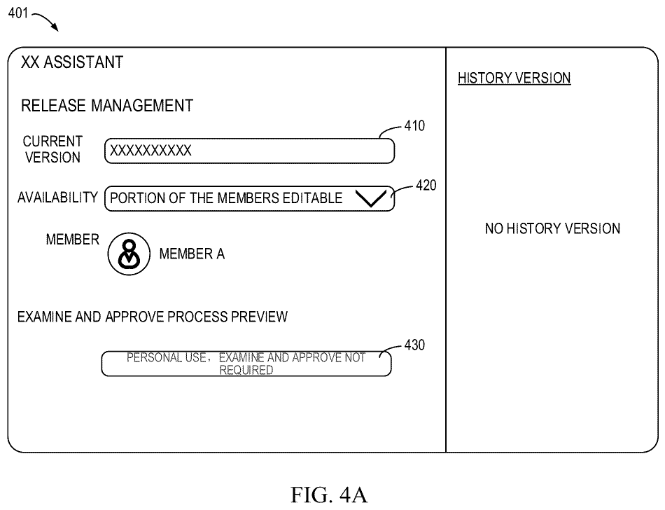

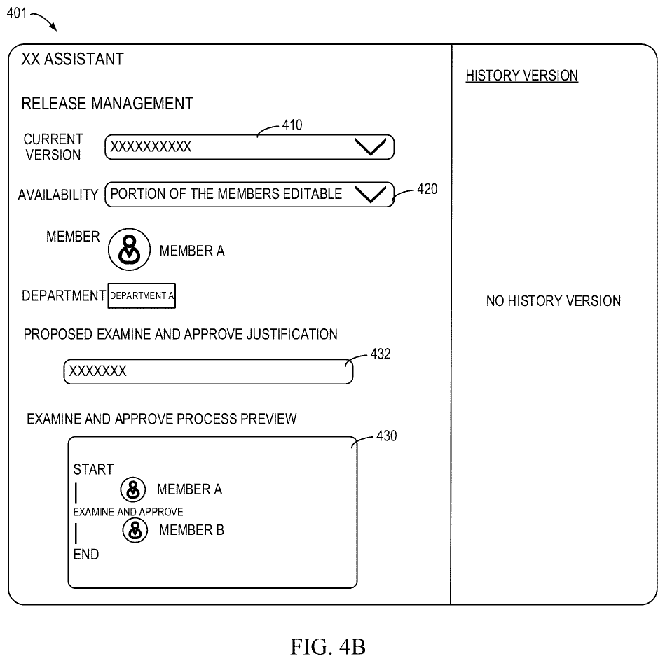

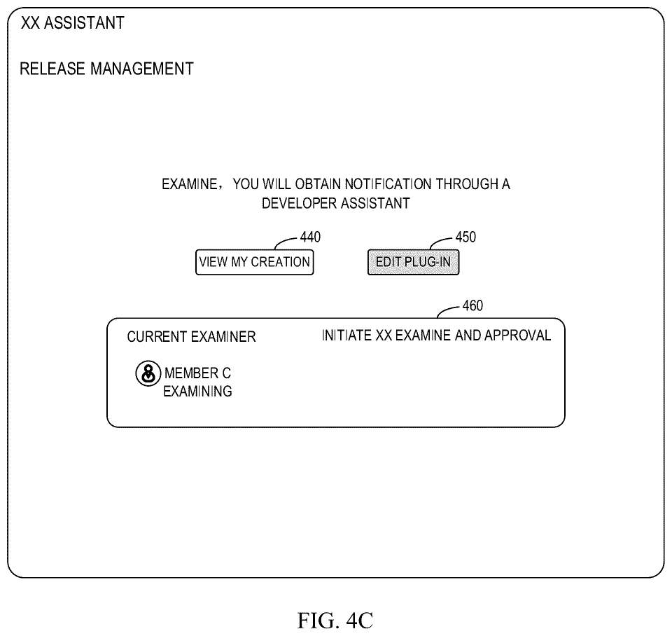

FIG. 4A to FIG. 4C illustrate schematic diagrams of an example release page 401 for releasing plug-in according to some embodiments of the present disclosure. In some embodiments, in response to the plug-in creation information of the plug-in being obtained in the creation page, the terminal device 110 may present the release page 401 for releasing the plug-in. An input portal 410 for inputting version information is presented in the release page 401. In some embodiments, the version number of the latest version of the plug-in may be directly presented in the input portal 410. The version number herein may be determined by the terminal device 110, or may be manually input by the user. In some embodiments, the terminal device 110 may further present the “historical version” of the control in association with the input portal in the release page. The terminal device 110 may present, in response to detecting a click operation of the “historical version”, historical version information associated with the plug-in to be released.

In some embodiments, the release page 401 also includes a permission editing control 420. The terminal device 110 may determine, based on the user input obtained at the permission editing control 420, that a user range capable of using the plug-in, that is, determine that at least one user capable of using the plug-in. At least one of the users here includes at least the current user who created the plug-in.

In some embodiments, in the scenario where the created plug-in is for private use, i.e., only used by the user who created the plug-in, only user information associated with the current user is presented in the release page 401. For example, as shown in FIG. 4A, if the current user is user A, the terminal device 110 only presents the user information (for example, the avatar, the name, and the like of the user A) of user A in association with the permission editing control 420. In some embodiments, in the scenario where the created plug-in is used for public use, i.e., the user creating the plug-in and at least one other user use the plug-in, the release page 401 may also present user information associated with all users capable of using the plug-in. For example, as shown in FIG. 4B, if the current user is user A, and the plug-in created by the user A is for public use for all user in the department where the user A is located, the terminal device 110 may present the user information (for example, the avatar and the name of the user A) of the user A in association with the permission editing control 420 and the department information (for example, the department name) of the department where the user A is located. It may be understood that, in addition to presenting the department information, in some embodiments, the terminal device 110 may also present the user information of the user A and the user information of all users of the department where the user A is located in association with the permission editing control 420. In this scenario, the digital assistant may make different replies to different inquirers based on the permission of the questioner. For example, in the scenario where plug-in A and plug-in B are included, if the user A only has the permission of the plug-in A, and the user B only has the permission of the plug-in B, the digital assistant replies to the user A by using the plug-in A, and replies to the user B by using the plug-in B. Even if user A and user B ask the same question to the digital assistant, the reply of the digital assistant to the two users may be different because they have different permissions.

In some embodiments, user-created plugins may be released to other users for use. In some embodiments, the plug-in to be released by the user needs to be released after the audit passes. In this case, the terminal device 110 may release the plug-in in response to the audit of the plug-in creation information is passed. In some embodiments, to enable the user to intuitively obtain the current audit status of the plug-in (for example, passing or not passing the audit), as shown in FIG. 4A and FIG. 4B, the release page 401 may further include an audit information presentation area 430. In the scenario where the created plug-in is used for private use, the audit information presentation area 430 may present a text prompt as shown in FIG. 4A, and the text prompt here is used to prompt the user that such a plug-in does not need to be audited by others, and may be directly released. When the created plug-in is used for public use, the audit information presentation area 430 may present the audit information as shown in FIG. 4B. The audit information herein may indicate the examiner auditing the plug-in (the examiner herein includes other users or machines, models, digital assistants, etc.), and the current audit node.

In some embodiments, the terminal device 110 may present the page as shown in FIG. 4C to the user in response to auditing. Such a page may include a text prompt as shown in FIG. 4C, and the text prompt here is used to prompt the user of the current audit status. Such pages may also include controls 440 for viewing the created tools and controls 450 for editing the created tools. Such a page may also include an audit information presentation area 460. Audit information presentation area 460 may present a text prompt as shown in FIG. 4C. The audit information herein may indicate information such as a current examiner.

In some embodiments, the terminal device 110 may present the prompt information to the user in response to the end of the audit. For example, the prompt information may be presented to the user in the manner of voice, vibration, text, or the like. The terminal device 110, in turn, in response to detecting a release operation indicating releasing the plug-in (for example, a touch operation such as a click operation on a release control, or a non-touch operation such as a voice instruction and a posture instruction), determines that a release instruction for the plug-in is received, and then release the plug-in.

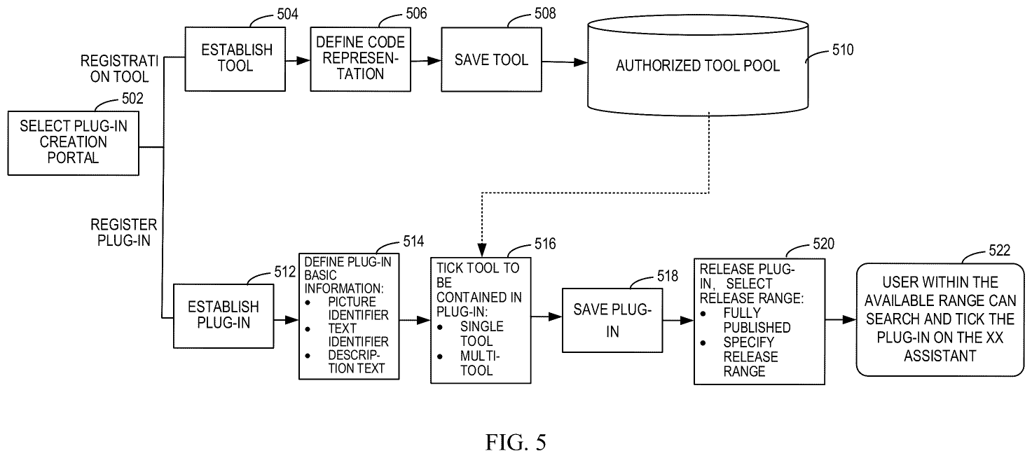

Some embodiments of related operations for creating plug-ins, creating tools, and releasing plug-ins are described above. An example architecture for tool creation and plug-in creation is described below with reference to FIG. 5.

As shown in FIG. 5, such an example architecture generally includes two parts of a registration tool and a registration plugin. At block 502, the terminal device 110 may enter the plug-in creation page via the plug-in creation portal in response to a selection operation by the user. At block 504, the terminal device 110 may enter tool creation page via a tool creation portal in the plug-in creation page in response to an operation of the user establishing a new tool. In block 506, the terminal device 110 may provide the code representation editing control and the code representation upload control to support the user in customizing the code representation of the tool to be newly established. At block 508, the terminal device 110 may, for example, verify the code representation in response to the selection operation of the save control by the user and save the tool after the verification passes. At block 510, the terminal device 110 may save the newly established tool in the tool pool. Further, the terminal device 110 may support setting permissions of tools in the tool pool, so as to provide tools conforming to the permission range of different users for different user.

At block 512, the terminal device 110 may provide a plurality of information input components in response to an operation of the user establishing the new plug-in. At block 514, the terminal device 110 may obtain basic information of the plug-in to be created, such as a picture identifier, a text identifier, description text, or the like, via the plurality of information input components. At block 516, the terminal device 110 may present the user with a list of tools within its range of permission. Further, the terminal device 110 may determine, in response to a user's ticking operation on the tool, tools included in the plug-in to be created. The plug-in to be created may contain a single tool or multiple tools. In block 518, the terminal device 110 may submit the plug-in to an audit in response to the selection operation of the save control by the user, and save the plug-in after the audit is passed. Additionally or alternatively, for the saving operation of the plug-in, the terminal device 110 may not check whether all required fields in the plug-in creation information are completely filled. For example, the terminal device 110 may save the information that has been filled in, and give the prompt information for the scenario where the required field is not filled. In block 520, the terminal device 110 may release the plug-in and select a release range of the plug-in. The release range may include a full public release or a specified release range. The specified release range is, for example, release to the certain users or users of a department within the enterprise.

The overall flow of the registering tools and configuring plug-ins is outlined above. At block 522, the terminal device 110 may, for the user's range of permission, present the plug-in in the user's digital assistant and support the user to tick the plug-in by searching.

In summary, according to various embodiments of the present disclosure, in an interaction window between a user and a digital assistant, a creation page for creating a target plug-in is provided. Support the user to directly configure plug-ins in such plug-in creation page without jumping to other applications (e.g., browsers) for configuration. Further, the user is enabled to directly edit the code or upload the code file without pre-storing the code or code file in another electronic device. Still further, it is possible to support the user to select the release range of the plug-in when releasing the plug-in, and only the user in the release range may use the plug-in.

Therefore, the plug-in can be conveniently and quickly created and shared to other users. In this way, the threshold and complexity of creating the plug-in can be reduced, thereby expanding the capability of the digital assistant.

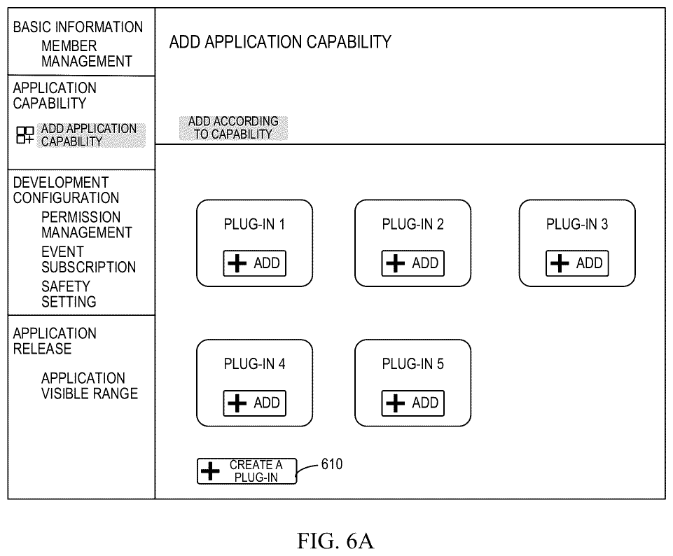

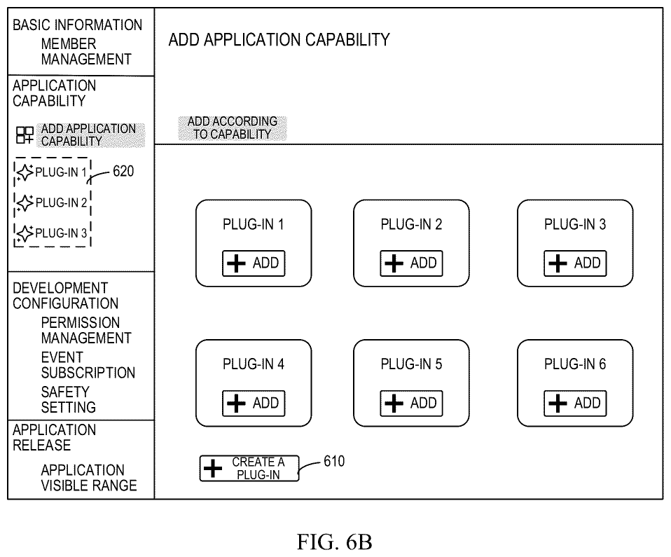

In some scenarios, some embodiments of the present disclosure may also support entering a plug-in creation page from an application development platform and performing a corresponding plug-in creation operation. FIG. 6A and FIG. 6B illustrate schematic diagrams of example pages of creating a plug-in in an application according to some embodiments of the present disclosure. Such an example page is provided, for example, by the terminal device 110 via an application creation page of an application development platform. In the example of FIG. 6A, the terminal device 110 may present a plurality of pre-stored or user uploaded plug-ins, such as the plug-in 1, the plug-in 2, . . . , the plug-in 5, and so on, in response to a user selection operation of adding an application capability. In the example of FIG. 6B, the terminal device 110 may present the added plugin region 620 in response to a user selection operation of the plugin. For example, the terminal device 110 displays the information of these plug-ins in the added plug-in area 620 in response to the selection operations of the plug-in 1, the plug-in 2, and the plug-in 3 by the user.

In some embodiments, as shown in the example interfaces of FIG. 6A and FIG. 6B, the terminal device 110 may provide a page (e.g., the page of FIG. 3A) for creating a plug-in in response to a selection operation of the plug-in creation control 610 by the user. The terminal device 110 may obtain the plug-in creation information via such a page. For example, the terminal device 110 may present the created plug-in in response to the user completing the plug-in creation and passing the verification, for example, the plug-in 6 shown in FIG. 6B. Additionally or alternatively, the newly established plug-in may also be presented in a primary location in the plug-in list, such as a location before an existing plug-in.

In some embodiments, all plugins under the same application have permission to the application, that is, the plugins have the same available range. For example, after the created plug-in is released successfully, a user within the available range may view the plug-in at the add application capability page shown in FIG. 6A and FIG. 6B.

It should be understood that some embodiments of the present disclosure are described above with reference to specific examples in the accompanying drawings, but these specific examples are not intended to limit the scope of the embodiments of the present disclosure. The described embodiments may also be implemented in various other deformation.

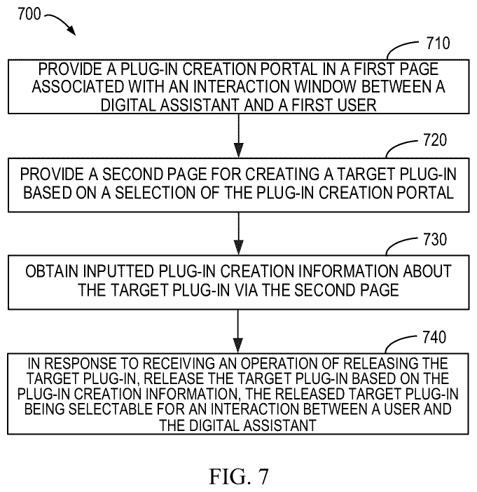

FIG. 7 illustrates a flowchart of a process 700 for creating a plug-in according to some embodiments of the present disclosure. Process 700 may be implemented at terminal device 110. For ease of discussion, the process 700 will be described with reference to the environment 100 of FIG. 1.

At block 710, the terminal device 110 provides a plug-in creation portal in a first page associated with an interaction window between a digital assistant and a first user.

In an embodiment, an interaction window between the first user and the digital assistant is a session window. The first page is a message display area of the session window.

At block 720, the terminal device 110 provides a second page for creating a target plug-in based on a selection of the plug-in creation portal.

In block 730, the terminal device 110 obtains inputted plug-in creation information about the target plug-in via the second page.

In block 740, the terminal device 110 in response to receiving an operation of releasing the target plug-in, releases the target plug-in based on the plug-in creation information, the released target plug-in being selectable for an interaction between a user and the digital assistant.

In some embodiments, the plug-in creation information comprises at least information of at least one tool contained in the target plug-in.

In some embodiments, the obtained plug-in creation information further comprises at least one of the following: identification information of the target plug-in, the identification information comprising a text identifier and/or an image identifier; a description text of the target plug-in; plug-in permission information indicating at least a user range capable of using the target plug-in.

In some embodiments, the first page further provides plug-in description information of a set of existing plug-ins associated with the digital assistant, wherein the plug-in description information comprises identification information of the set of existing plug-ins.

In some embodiments, the process 700 further includes: in response to the target plug-in being released, updating the plug-in description information to comprise identification information of the target plug-in.

In some embodiments, obtaining the inputted plug-in creation information about the target plug-in comprises: displaying a set of candidate tools in the second page; and determining the plug-in creation information based at least on a selection by the first user for a first tool in the set of candidate tools.

In some embodiments, the set of candidate tools comprises at least one of: a first set of candidate tools determined based on permission information of the first user; a second set of candidate tools edited or uploaded by the first user; a third set of candidate tools determined based on a target application associated with the target plug-in.

In some embodiments, determining the plug-in creation information based at least on the selection by the first user for the first tool in the set of candidate tools comprises: determining the selected first tool to be a tool to be comprised in the target plug-in.

In some embodiments, determining the plug-in creation information based at least on the selection by the first user for the first tool in the set of candidate tools comprises: receiving an editing operation by the first user with respect to the first tool; and determining the edited first tool to be a tool to be comprised in the target plug-in.

In some embodiments, obtaining the inputted plug-in creation information about the target plug-in comprises: obtaining, via the second page, tool creation information about a second tool to be created from the first user; creating the second tool based on the tool creation information; and determining the created second tool to be a tool to be comprised in the target plug-in.

In some embodiments, the tool creation information comprises at least a code representation associated with the second tool.

In some embodiments, the code representation comprises: a first code representation inputted via a code edit control in the second page; and/or a second code representation uploaded by the first user.

In some embodiments, creating the second tool based on the tool creation information comprises: in response to the code representation passing a verification, creating the second tool.

In some embodiments, the process 700 further comprises: in response to the code representation failing to pass the verification, providing an error prompt associated with the code representation.

In some embodiments, the tool creation information further comprises tool permission information indicating a usage constraint by at least one other user with respect to the second tool.

In some embodiments, releasing the target plug-in comprises: in response to an audit of the plug-in creation information being passed, releasing the target plug-in.

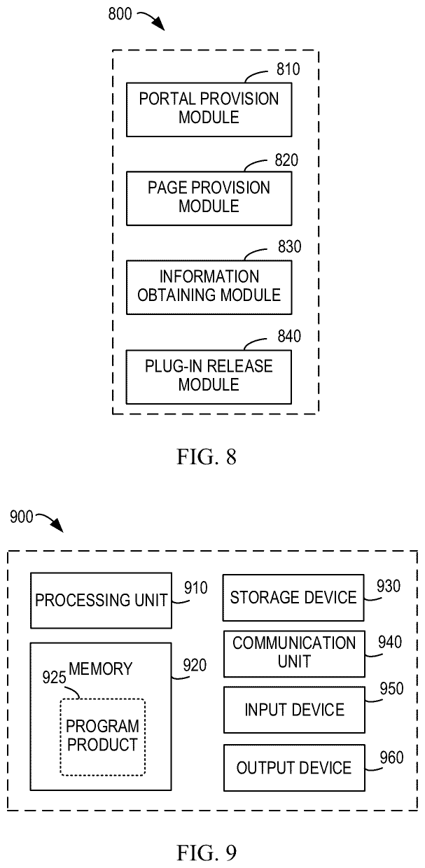

FIG. 8 illustrates a schematic structural block diagram of an apparatus 800 for creating a plug-in according to some embodiments of the present disclosure. The apparatus 800 may be implemented or included in the terminal device 110. The various modules/components in the apparatus 800 may be implemented by hardware, software, firmware, or any combination thereof.

The apparatus 800 includes a portal provision module 810, configured to provide a plug-in creation portal in a first page associated with an interaction window between a digital assistant and a first user. The apparatus 800 further includes a page provision module 820, configured to provide a second page for creating a target plug-in based on a selection of the plug-in creation portal. The apparatus 800 further includes an information obtaining module 830, configured to obtain inputted plug-in creation information about the target plug-in via the second page. The apparatus 800 further includes a plug-in release module 840, configured to in response to receiving an operation of releasing the target plug-in, release the target plug-in based on the plug-in creation information, the released target plug-in being selectable for an interaction between a user and the digital assistant.

In an embodiment, an interaction window between the first user and the digital assistant is a session window. The first page is a message display area of the session window.

In some embodiments, the plug-in creation information comprises at least information of at least one tool contained in the target plug-in.

In some embodiments, the obtained plug-in creation information further comprises at least one of the following: identification information of the target plug-in, the identification information comprising a text identifier and/or an image identifier; a description text of the target plug-in; plug-in permission information indicating at least a user range capable of using the target plug-in.

In some embodiments, the first page further provides plug-in description information of a set of existing plug-ins associated with the digital assistant, wherein the plug-in description information comprises identification information of the set of existing plug-ins.

In some embodiments, the apparatus 800 further includes a plug-in description information updating module configured to, in response to the target plug-in being released, update the plug-in description information to comprise identification information of the target plug-in.

In some embodiments, the information obtaining module 830 is configured to display a set of candidate tools in the second page; and determine the plug-in creation information based at least on a selection by the first user for a first tool in the set of candidate tools.

In some embodiments, the set of candidate tools comprises at least one of: a first set of candidate tools determined based on permission information of the first user; a second set of candidate tools edited or uploaded by the first user; a third set of candidate tools determined based on a target application associated with the target plug-in.

In some embodiments, the information obtaining module 830 is configured to determine the selected first tool to be a tool to be comprised in the target plug-in.

In some embodiments, the information obtaining module 830 is configured to receive an editing operation by the first user with respect to the first tool; and determine the edited first tool to be a tool to be comprised in the target plug-in.

In some embodiments, the information obtaining module 830 is configured to obtain, via the second page, tool creation information about a second tool to be created from the first user; create the second tool based on the tool creation information; and determine the created second tool to be a tool to be comprised in the target plug-in.

In some embodiments, the tool creation information comprises at least a code representation associated with the second tool.

In some embodiments, the code representation comprises: a first code representation inputted via a code edit control in the second page; and/or a second code representation uploaded by the first user.

In some embodiments, the information obtaining module 830 is configured to, in response to the code representation passing a verification, create the second tool, and the apparatus 800 further includes an error prompt provision module, configured to in response to the code representation failing to pass the verification, provide an error prompt associated with the code representation.

In some embodiments, the tool creation information further comprises tool permission information indicating a usage constraint by at least one other user with respect to the second tool.

In some embodiments, the plug-in release module 840 is configured to in response to an audit of the plug-in creation information being passed, release the target plug-in.

The units and/or modules included in the apparatus 800 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 800 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or a combination of electronic devices may include, for example, the server 130, the terminal device 110, and/or a combination of the server 130 and the terminal device 110 in FIG. 1.

FIG. 9 illustrates a block diagram of an electronic device 900 in which one or more embodiments of the present disclosure may be implemented. It should be understood that the electronic device 900 illustrated in FIG. 9 is merely exemplary and should not constitute any limitation on the functionality and scope of the embodiments described herein. The electronic device 900 shown in FIG. 9 may be configured to implement the terminal device 110 in FIG. 1.

As shown in FIG. 9, the electronic device 900 is in the form of a general-purpose electronic device. Components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to programs stored in the memory 920. In multiprocessor system, multiple processing units execute computer-executable instructions in parallel to improve parallel processing capabilities of electronic device 900.

Electronic device 900 typically includes a plurality of computer storage media. Such media may be any available media accessible to the electronic device 900, including, but not limited to, volatile and non-volatile media, removable and non-removable media. The memory 920 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 930 may be a removable or non-removable medium and may include a machine-readable medium, such as a flash drive, magnetic disk, or any other medium, which may be capable of storing information and/or data and may be accessed within electronic device 900.

The electronic device 900 may further include additional removable/non-removable, volatile/non-volatile storage media. Although not shown in FIG. 9, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 920 may include a computer program product 925 having one or more program modules configured to perform various methods or actions of various embodiments of the present disclosure.

The communication unit 940 is configured to communicate with another electronic device through a communication medium. Additionally, the functionality of components of the electronic device 900 may be implemented in a single computing cluster or multiple computing machines capable of communicating over a communication connection. Thus, the electronic device 900 may operate in a networked environment using logical connections with one or more other servers, network personal computers (PCs), or another network Node.

The input device 950 may be one or more input devices, such as a mouse, a keyboard, a trackball, or the like. The output device 960 may be one or more output devices, such as a display, a speaker, a printer, or the like. The electronic device 900 may also communicate with one or more external devices (not shown) through the communication unit 940 as needed, external devices such as storage devices, display devices, etc., communicate with one or more devices that enable a user to interact with the electronic device 900, or communicate with any device (e.g., a network card, a modem, etc.) that enables the electronic device 900 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function.

In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for creating a plug-in, comprising:
providing a plug-in creation portal in a first page associated with an interaction window between a digital assistant and a first user;
providing a second page for creating a target plug-in based on a selection of the plug-in creation portal;
obtaining inputted plug-in creation information about the target plug-in via the second page; and
in response to receiving an operation of releasing the target plug-in, releasing the target plug-in based on the plug-in creation information, the released target plug-in being selectable for an interaction between a user and the digital assistant.

2. The method of claim 1, wherein the plug-in creation information comprises at least information of at least one tool contained in the target plug-in.

3. The method of claim 1, wherein the obtained plug-in creation information further comprises at least one of the following:
identification information of the target plug-in, the identification information comprising a text identifier and/or an image identifier;
a description text of the target plug-in;
plug-in permission information indicating at least a user range capable of using the target plug-in.

4. The method of claim 1, wherein the first page further provides plug-in description information of a set of existing plug-ins associated with the digital assistant, wherein the plug-in description information comprises identification information of the set of existing plug-ins.

5. The method of claim 4, further comprising:
in response to the target plug-in being released, updating the plug-in description information to comprise identification information of the target plug-in.

6. The method of claim 1, wherein obtaining the inputted plug-in creation information about the target plug-in comprises:
displaying a set of candidate tools in the second page; and
determining the plug-in creation information based at least on a selection by the first user for a first tool in the set of candidate tools.

7. The method of claim 6, wherein the set of candidate tools comprises at least one of:
a first set of candidate tools determined based on permission information of the first user;
a second set of candidate tools edited or uploaded by the first user; and
a third set of candidate tools determined based on a target application associated with the target plug-in.

8. The method of claim 6, wherein determining the plug-in creation information based at least on the selection by the first user for the first tool in the set of candidate tools comprises:
determining the selected first tool to be a tool to be comprised in the target plug-in.

9. The method of claim 6, wherein determining the plug-in creation information based at least on the selection by the first user for the first tool in the set of candidate tools comprises:
receiving an editing operation by the first user with respect to the first tool; and
determining the edited first tool to be a tool to be comprised in the target plug-in.

10. The method of claim 1, wherein obtaining the inputted plug-in creation information about the target plug-in comprises:
obtaining, via the second page, tool creation information about a second tool to be created from the first user;
creating the second tool based on the tool creation information; and
determining the created second tool to be a tool to be comprised in the target plug-in.

11. The method of claim 10, wherein the tool creation information comprises at least a code representation associated with the second tool.

12. The method of claim 11, wherein the code representation comprises:
a first code representation inputted via a code edit control in the second page; and/or
a second code representation uploaded by the first user.

13. The method of claim 11, wherein creating the second tool based on the tool creation information comprises: in response to the code representation passing a verification, creating the second tool, and
wherein the method further comprises: in response to the code representation failing to pass the verification, providing an error prompt associated with the code representation.

14. The method of claim 10, wherein the tool creation information further comprises tool permission information indicating a usage constraint by at least one other user with respect to the second tool.

15. The method of claim 1, wherein releasing the target plug-in comprises:
in response to an audit of the plug-in creation information being passed, releasing the target plug-in.

16. The method of claim 1, wherein,
the interaction window between the first user and the digital assistant is a session window; and
the first page is a message presentation area of the session window.

17. An electronic device, comprising:
at least one processing unit; and
at least one memory coupled to the at least one processing unit and storing instructions for execution by the at least one processing unit, the instructions, when executed by the at least one processing unit, causing the electronic device to perform at least:
providing a plug-in creation portal in a first page associated with an interaction window between a digital assistant and a first user;
providing a second page for creating a target plug-in based on a selection of the plug-in creation portal;
obtaining inputted plug-in creation information about the target plug-in via the second page; and
in response to receiving an operation of releasing the target plug-in, releasing the target plug-in based on the plug-in creation information, the released target plug-in being selectable for an interaction between a user and the digital assistant.

18. The electronic device of claim 17, wherein the plug-in creation information comprises at least information of at least one tool contained in the target plug-in.

19. The electronic device of claim 17, wherein the obtained plug-in creation information further comprises at least one of the following:
identification information of the target plug-in, the identification information comprising a text identifier and/or an image identifier;
a description text of the target plug-in;
plug-in permission information indicating at least a user range capable of using the target plug-in.

20. A non-transitory computer-readable storage medium having a computer program stored thereon, the computer program being executable by a processor to implement a method comprising:
providing a plug-in creation portal in a first page associated with an interaction window between a digital assistant and a first user;
providing a second page for creating a target plug-in based on a selection of the plug-in creation portal;
obtaining inputted plug-in creation information about the target plug-in via the second page; and
in response to receiving an operation of releasing the target plug-in, releasing the target plug-in based on the plug-in creation information, the released target plug-in being selectable for an interaction between a user and the digital assistant.
